(19) United States
(12) Patent Application Publication
(10) Pub. No.: US 2009/0027462 A1
(43) Pub. Date: Jan. 29, 2009

(54) WIDE FORMAT INK CARTRIDGE

(76) Inventor: Richard H. Berg, Hilton, NY (US)

Correspondence Address: FAY SHARPE LLP, 1100 SUPERIOR AVENUE, SEVENTH FLOOR, CLEVELAND, OH, 44114, US

(21) Appl. No.: 12/178,938

(22) Filed: Jul. 24, 2008

Related U.S. Application Data
(60) Provisional application No. 60/961,779, filed on Jul. 24, 2007.

(51) Int. Cl. B41J 2/175

(52) U.S. Cl. 347/86

(57) ABSTRACT

An ink cartridge has a first wall and a plurality of side walls extending from the first wall to form an internal cavity between the side walls and the first wall. The internal cavity is substantially filled with ink. A cover is attached to the plurality of the walls. An ink supply port is formed in one of the plurality of side walls. An ink supply flow path is formed in the first wall and extends to the ink supply port. A porous member is interposed between the ink supply flow path and the ink supply port or a wall of the cartridge for minimizing formation of bubbles in ink in the ink supply flow path and the ink supply port. Grooves are also provided in the ink supply flow path to further reduce formation of bubbles.

### CLAIM OF PRIORITY

This patent application claims priority from U.S. Provisional Patent Application No. 60/961,779 filed on Jul. 24, 2007, the contents of which are incorporated herein by reference.

### BACKGROUND OF THE INVENTION

The present invention relates to an ink cartridge and an ink cartridge holder. More particularly, the present invention relates to the ink cartridge for supplying ink to a recording apparatus.

Generally, an ink jet recording apparatus is designed to print data by causing the recording head to move back and forth along the width of a recording sheet. Ink is supplied from an ink supply source to the recording head. As a result, the ink jet recording apparatus that must produce a large number of copies must carry a larger-sized ink cartridge which cannot be mounted on a carriage. Thus, the ink cartridge is mounted on the housing of the recording apparatus, and the ink may be supplied to the recording head through a tube.

An ink jet recording apparatus can be provided which includes an ink cartridge holder on which an ink cartridge filled with ink is detachably mounted. A large-size ink cartridge is used for the ink jet recording apparatus which records on large-size papers, such as posters or the like, in order to cope with a large quantity of ink consumption.

The ink cartridge used for the ink jet recording apparatus may be provided with a memory device or chip which stores information, such as a type of ink, color of ink, remaining amount of ink and the like. An information reading section is provided on the ink cartridge holder at a position facing the chip when the ink cartridge is mounted on the ink cartridge holder, and the chip on the ink cartridge and the information reading section on the ink cartridge holder are electrically connected and communicate with each other.

Existing wide format ink cartridges often have a bag or collapsible ink reservoir contained within a rigid housing. An example of such a cartridge is shown in U.S. Pat. No. 6,053,606. A problem with this arrangement is that as the bag collapses, pockets of ink become trapped in the bag, thus reducing the efficiency of the cartridge. Also, air bubbles may form in the ink supply port, and become trapped as well, which may result in imaging defects at the printer. The printer is designed to allow the customer to remove the cartridge to swap out different colors within the same port. Every time the cartridge is re-inserted into the printer, air is injected into the cartridge and positioned within the same compartment where the ink needle will be. This will provide the opportunity for air to be suctioned into the printer's ink line and create imaging defects such as missing jets or the entire color to deprime. Each cartridge insert adds significantly more air into the cartridge, thus, drastically accelerating printing failure. As the ink is consumed from printing, it can be expected that the customer will swap different colors based on the design of the printer. If the cartridge is laid on its side where the ink inlet is at the elevated position, air will enter into the ink fluid channel due to density of the two fluids. Upon re-inserting this cartridge back into the printer's port, the air due to buoyancy will float into the horizontal chambers where the printer's ink needle is located.

Trapped air bubbles in the ink fluid path are suctioned into the printer's ink. This trapped air results in missing jets or depriming of the entire color in the printing images.

There are at least four ways for bubbles to be formed in compartments of the ink fluid flow path of the cartridge. A first way is during ink filling of the cartridge, which may leave initial air bubbles in the fluid path section. If the cartridge is vacuum filled, air will be left behind in the cartridge after filling the cartridge. The air enters into the ink fluid flow path of the cartridge by orientating the air bubbles at the inlet. A second way that air bubbles are formed is during packaging and shipment of the cartridge. A third way is if the cartridge is laid flat on the table, air bubbles will wick into the fluid passage and float forward and possibly deprime the cartridge.

Fourth, as the cartridge is inserted into the printer, the design of the septum or valve in the ink supply port will trap free air as the ink travels from the cartridge to the printer. The rubber septum has a cylindrical cavity but seals to the outer diameter of the printer's ink needle by a compression fit. The nose of the printer's ink needle is typically a tapered cylinder which traps the air in the cylindrical volume of the rubber septum. This trapped air is squeezed into the ink cartridge's fluid compartment(s).

Thus, it is desirable to provide an ink cartridge which overcomes the above-mentioned deficiencies and others while providing better and overall more advantageous results.

### SUMMARY OF THE INVENTION

The present invention relates to an ink cartridge. More particularly, it relates to a wide format ink cartridge for use with an ink cartridge holder.

In accordance with one aspect of the invention, an ink cartridge has a first wall; a plurality of side walls extending from the first wall to form an internal cavity between the side walls and the first wall, the internal cavity is substantially filled with ink; a cover which is attached to the plurality of the walls; an ink supply port formed in one of the plurality of side walls; an ink supply flow path formed in the first wall and extending to the ink supply port; and, a porous member interposed between the ink supply flow path and the ink supply port for minimizing formation of bubbles in ink in the ink supply flow path and ink supply port.

In accordance with another aspect of the invention, an ink cartridge has a first wall; a plurality of side walls extending from the first wall to form an internal cavity between the side walls and the first wall, wherein the internal cavity is substantially filled with ink; a cover which is attached to the plurality of said walls; an ink supply port formed in one of the plurality of side walls; an ink supply flow path formed in the first wall and extending to the ink supply port; wherein the ink supply flow path comprises an inlet adjacent one of the side walls; and a porous member positioned between the inlet of the ink supply flow path and the one of the side walls for minimizing formation of bubbles in ink in the ink supply flow path.

One aspect of the present invention is the provision of providing a porous member or filter in the ink supply port adjacent an ink flow path to prevent bubbles from forming in the ink.

Another aspect of the present invention is the provision of grooves formed in an ink supply path for preventing bubbles from forming in the ink.

Another aspect of the present invention is the provision of an ink cartridge which holds ink in an internal cavity without the use of a bag.

Other aspects of the invention will become apparent upon a reading and understanding of the following detail description.

### BRIEF DESCRIPTION OF THE DRAWINGS

The foregoing advantages of the present invention, and others, will in part be obvious and in part pointed out more fully hereinafter in conjunction with the written description of the embodiments illustrated in the accompanying drawings in which:

FIG. 1 is a perspective view of a front side of an ink cartridge in accordance with a first embodiment of the present invention;

FIG. 2 is a partial elevational view of a side wall of the ink cartridge of FIG. 1;

FIG. 3 is a front elevational view of a front wall of the cartridge of FIG. 1;

FIG. 4 is a perspective view of the rear side of the cartridge of FIG. 1;

FIG. 5 is a perspective view of an ink cartridge holder which receives the ink cartridge of FIG. 1;

FIG. 6 is a top plan view of an ink cartridge being inserted into the ink cartridge holder of FIG. 5;

FIG. 7 is a top plan view of the ink cartridge of FIG. 1 with the cover removed;

FIG. 8 is a perspective view of the ink cartridge of FIG. 1 showing the cover installed;

FIG. 9 is a side elevational view in cross section of a porous member in accordance with the preferred embodiment of the invention;

FIG. 9A is a plan view of a filter of FIG. 9;

FIG. 10 is a plan view of a cross section of the ink supply port illustrating grooves in accordance with a preferred embodiment of the present invention;

FIG. 11 is a perspective view of a porous media at an inlet of the ink fluid flow path in accordance with a second embodiment of the present invention;

FIG. 12 is a perspective view of a porous media at an inlet of the ink fluid flow path in accordance with a third embodiment of the present invention; and

FIG. 12A is an enlarged view of the porous media of FIG. 12.

### DETAILED DESCRIPTION OF THE INVENTION

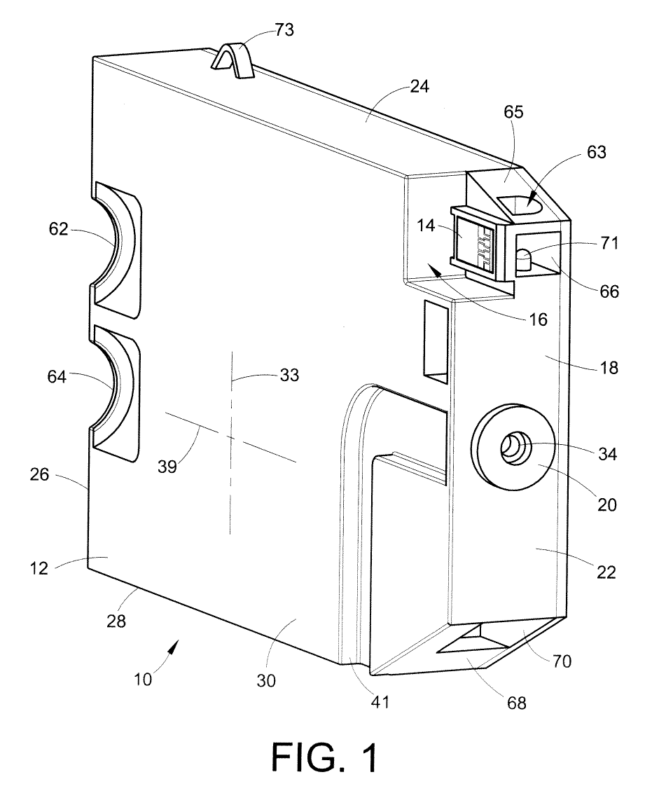

Referring now in greater detail to the drawings, wherein the showings are for the purpose of illustrating preferred embodiments of the invention only and not for the purpose of limiting the invention, FIG. 1 is a front perspective view of the ink cartridge according to the first embodiment of the present invention An ink cartridge 10 according to the first embodiment includes an ink cartridge main body 12 having a substantially rectangular parallel piped shape, an information storing unit 14 provided on a recess 16 which is adjacent a first side or a first wall 18 of the ink cartridge main body, and an ink supply unit 20 provided on a front surface 22 of wall 18. The body is formed by side walls 18, 24, 26, 28 and wall 30.

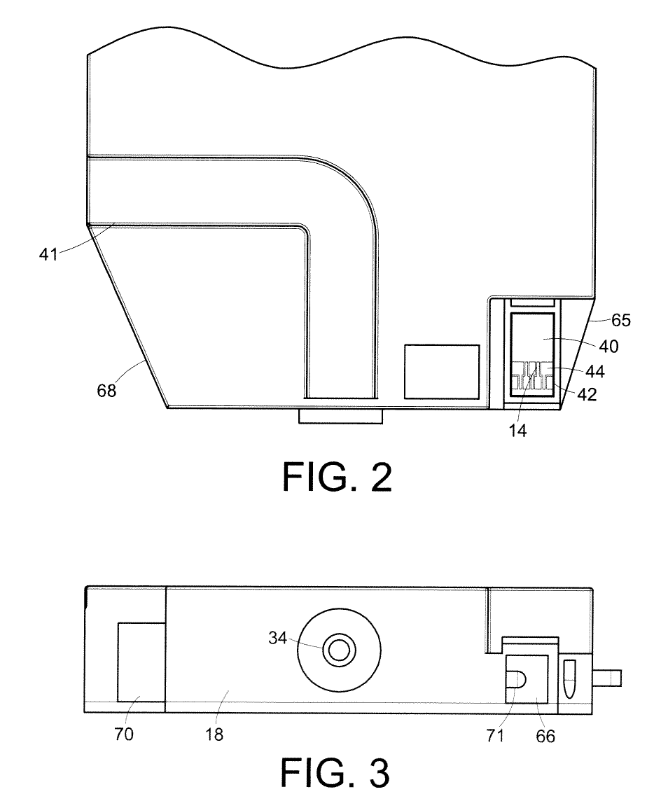

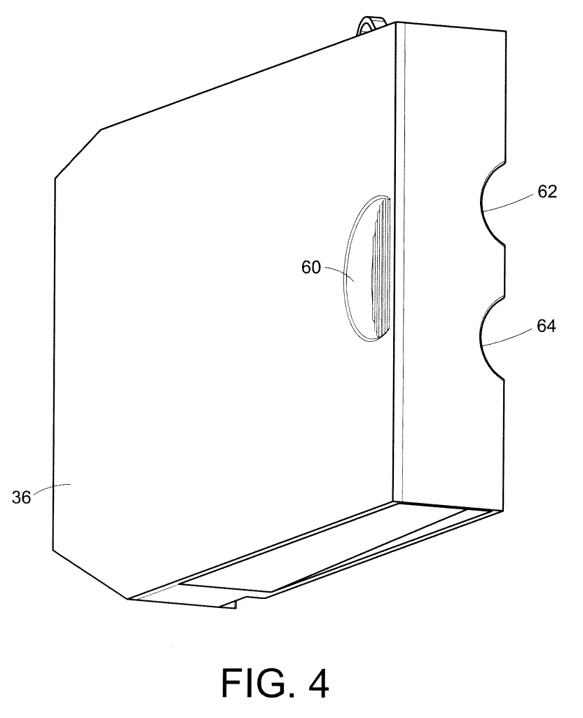

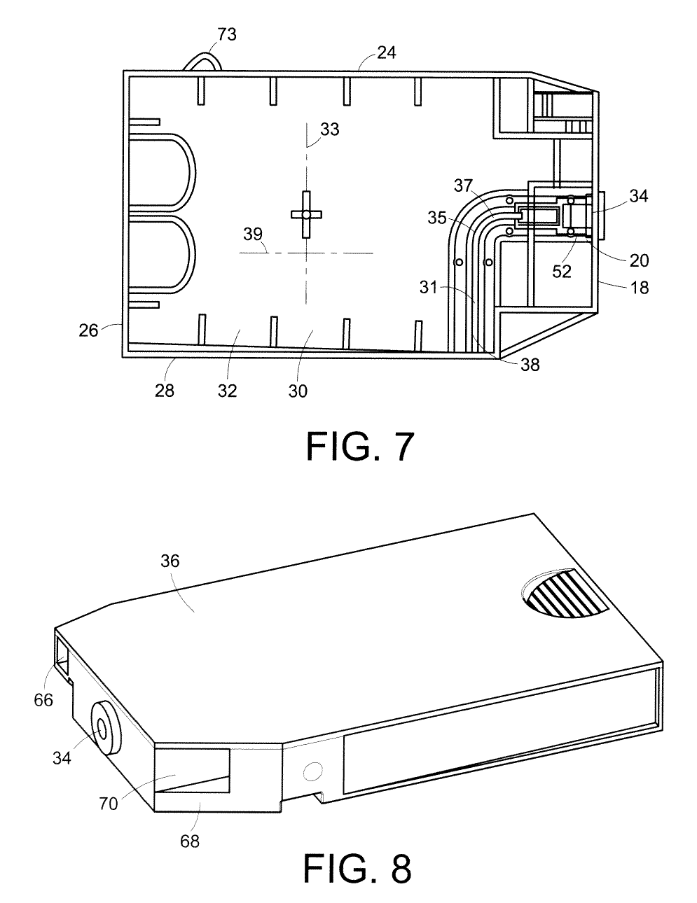

The ink cartridge main body includes a cavity 32 with one side being open, an ink supply port 34 (FIG. 3) provided at end 18 and is fixed to end 18, and a substantially flat cover plate 36 (FIG. 4). In this ink cartridge main body, the internal cavity 32 of the cartridge is substantially filled up with ink. The internal cavity 32 is formed by walls 18, 24, 26, 28, and 30 of the main body. An ink supply flow path 38 (FIG. 7) such as a channel for facilitating flow of ink from the main body to the ink supply port is provided in a recess 41 (FIG. 2) of wall 30. The channel 38 has a first, straight portion 31 extending along a first axis 33 of the body and a curved portion 35 connecting a second straight portion 37 extending perpendicular to first portion 31 and along second axis 39 of the body. The cover is fixed to the side walls 18, 24, 26, 28 of the container main body, such as by vibration, welding, or the like, with the internal cavity 32 of the container being enclosed by the cover. Thereby, a large quantity of ink is held and the large quantity of the ink is supplied to the ink jet recording apparatus stably which records on large-size papers such as posters or the like.

The information or memory storing unit 14 of the ink cartridge stores information, such as a type of ink and the ink cartridge, color of the ink in the ink cartridge, and remaining amount of the ink. For example, as shown in FIG. 2, the information storing unit is a contact type chip. The contact type chip includes a substrate 40, a connection electrode section 42 including a plurality of connection terminals 44 which are exposed to the front surface of the substrate, and memory including a semiconductor memory element, such as EEPROM provided on a back side of the substrate. The information data in the memory is read or rewritten through the connection terminals 44 electrically connecting with connection electrodes of the recording apparatus. In the present embodiment, the information storing or memory unit is of a contact type which is provided with the connection electrode section 42 including the plurality of connection terminals 44 exposed outside.

Seven connection terminals are typically arranged adjacent each other in the present embodiment as shown in FIG. 2. Alternatively, for example, the memory of the information storing unit may be provided on the other wall of the cartridge main body or the like and connects with the connection electrode section, which is provided on the first wall, via a flexible print circuit (FPC).

The recess 16 may be provided adjacent the first wall 18 of the ink cartridge main body as shown in FIG. 2. The information storing or memory unit and the connection electrode section are arranged in the recess. Moreover, since the upper part of the connection terminal surface is opened to the outside in the recess, the information storing unit is easily mounted on the ink cartridge main body during manufacturing of the ink cartridge.

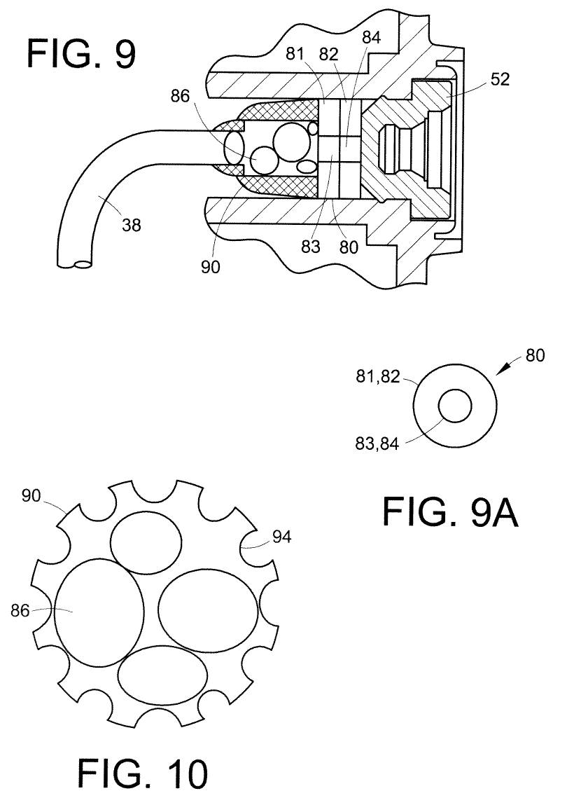

The ink supply port 34 is provided in the ink supply section of the ink cartridge, and the ink is supplied to the recording apparatus main body from the ink cartridge through the ink supply port. An ink supply needle 50 (FIG. 6) of the recording apparatus is inserted in the ink supply port. A valve or septum 52 (FIG. 9), which can be perforated or have a slit, is penetrated by insertion of the ink supply needle, and is provided within the ink supply port.

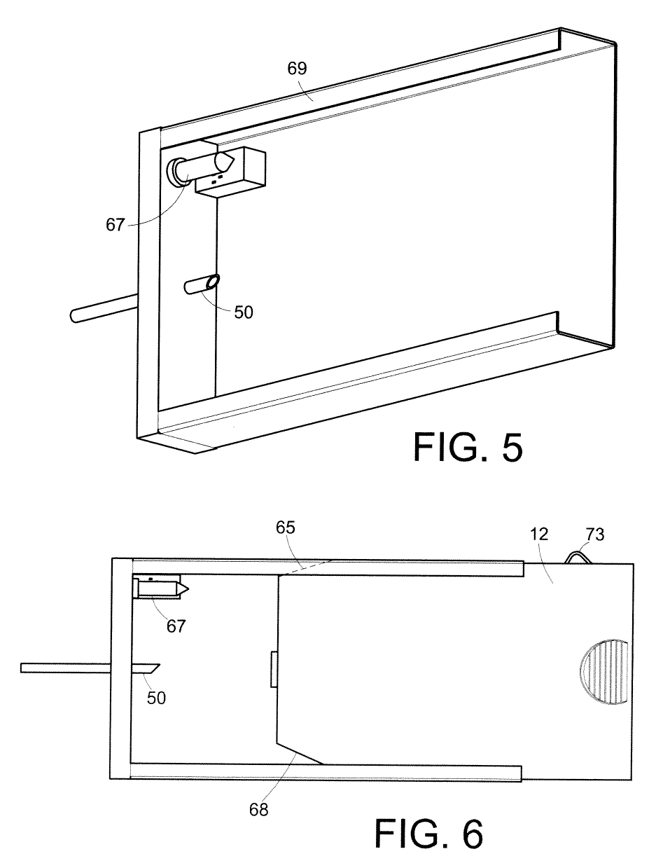

Referring to FIG. 4, in the rear side of the ink cartridge, there includes a gripping portion 60 and two finger indentations or recesses 62, 64 for enabling a user to securely grip the ink cartridge, and to easily attach/detach the ink cartridge to/from the ink cartridge holder of the ink jet recording apparatus. Referring to FIGS. 1, 3 and 8, at a front end of the cartridge, the cartridge further has a substantially square-shaped opening 66 positioned adjacent the memory unit into which a positioning rod 67 (FIG. 5) of the ink cartridge holder 69 may extend. A spring biased pin 71 may be depressed and keep a positioning rod aligned within opening 66. An angled or sloped surface is formed adjacent opening 66 and the memory device 14. On the other side of the cartridge, an angled surface 68 is formed in which a slotted opening 70 is formed. A second positioning member (not shown) of the ink cartridge holder may extend into the slotted opening. A projecting member 73 (FIGS. 1, 7) extending from side wall 24 helps guide and align the cartridge into its holder. The projecting member may be flexible or biased. The angled surfaces 65 and 68 at an upper corner and a lower corner help align, locate and center the cartridge and guide it into the holder as it is inserted as seen in FIG. 6. The upper angled wall also serves as a shield for the cartridge venting mechanism (pin 71 which is spring biased) which may allow ink to escape if depressed prior to insertion into the printer. A recess 63 is also provided for the venting mechanism to catch any ink that may leak from around the vent seal during insertion.

Referring to FIG. 6, the front surface of the cartridge is inserted into the holder main body of the ink cartridge holder. Positioning members of the holder oppose opening 66 and slotted opening 70. The ink supply needle 50 of the holder is positioned opposite the ink supply port 34 of the ink cartridge. The ink cartridge is slid into the holder cavity until the connection electrodes of the information reading section of the holder controls connection terminals of the connection electrode section of the information sharing unit in the ink cartridge.

Existing cartridges which have bags or collapsible ink reservoirs have an ink supply fluid path that comes directly in contact with the printer's ink needle. Bubbles in the ink ranging in size and frequency may be formed in the ink flow path. Bubbles may also form in the ink bag, and pockets of ink may become trapped in the bag as it collapses during depletion of the ink. Thus, the efficiency of the ink cartridge is reduced. Another problem with this configuration is that air bubbles may be ingested into the printer's ink and create imaging defects. Printheads typically contain a filter for each color of ink. Over time, the bubbles formed in the ink will accumulate at the filter and impede the flow rate which is a function of the area solid coverage. Several bubbles may coalesce to form a single but larger bubble over time. Oftentimes the user uses the power cleaning setting on the printer to attempt to evacuate air from the printhead. Attempts have also been made to manually evacuate air from the printhead with a syringe to impart higher negative pressure in order to purge the air.

In accordance with the preferred embodiment of the present invention, a filter or porous member 80 coupled with bubble management geometry in the cartridge can be used to reduce or minimize air bubbles in the ink.

Referring specifically to FIGS. 9 and 9A, a porous member 80 which may include two circular filter media 81, 82 are placed into the cartridge ink supply port 34 adjacent septum 52 with holes 83, 84 punched therethrough which allows for the printer's ink needle to pass through the filter media. The holes are smaller in diameter than the diameter of the ink needle such that a compression fit is formed between the needle and the filter so there is minimal opportunity for any bubbles to wick into the ink flow path.

The porous members or filters 81, 82 can be fabricated from porous material such as any wicking material or capillary system, such as a felt material or foam. These materials are chemically compatible with the ink. Typical materials can be PP, Nylon, or PET or a combination thereof. The wicking material can be unidirectional fibers bundled to create a capillary system. The thickness and porosity of the filters prevents air bubbles 86 from getting into the ink flow path.

The wicking material can also serve to assist the ink fluid path in the cartridge to maintain the primed condition of the cartridge when the cartridge is laid on its side. Without wicking material, the ink path may deprime if the cartridge is laid on its side.

Grooves 90 may be formed in the ink supply path adjacent to the filter 80. The grooves may longitudinally extend into the ink flow path and are sized to minimize or not allow bubbles to enter into the grooves. Referring now to FIG. 10, as a cross section of the fluid path containing bubbles shows, the grooves may have sharp corners or radiused corners 94 as shown in FIG. 10. Also, if the cross section of the fluid path changes in diameter from smaller diameter to a larger diameter, the grooves can be similarly sized to follow the path but will be scaled to smaller diameter so the fluid path maintains continuity. The grooves act as inherent capillaries which will stay wet with ink over any bubble attachment site. The groove profiles that are curved or sharp corners are inherently unstable for a bubble to stick to.

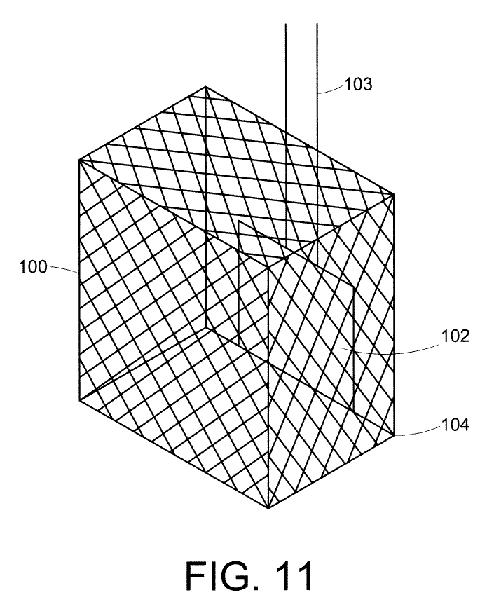

An alternate embodiment shown in FIG. 11, would include a wire mesh or porous media 100 in which all four surfaces will prevent large bubbles from entering a small fluid inlet 102 of an ink fluid flow channel 103 that is located at the floor or bottom wall 104 of the cartridge in order to siphon the ink into the ink fluid flow path. The wire mesh partial box can be heat staked to the cartridge. Also, the bottom surface of the cartridge may be recessed with a groove for installing the wire mesh box.

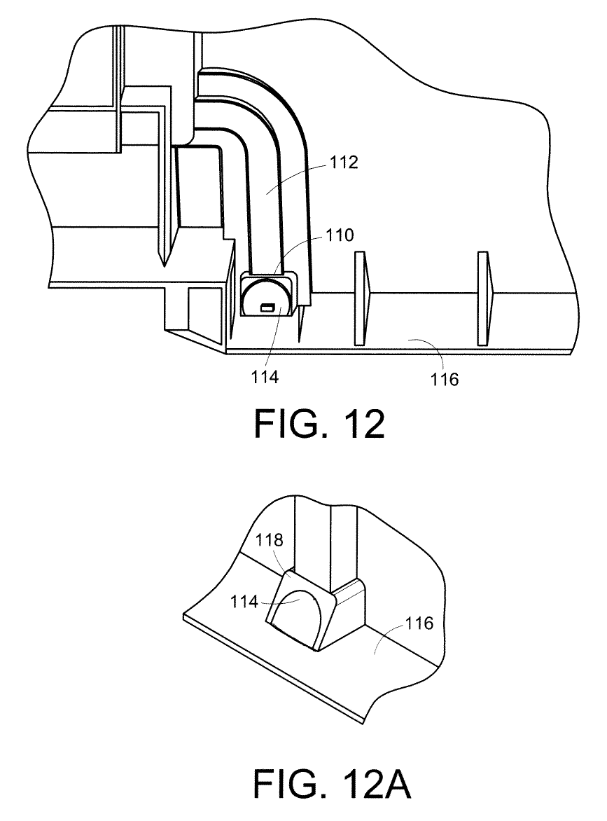

A third embodiment is shown in FIGS. 12 and 12A. Air bubbles can enter an inlet 110 to a fluid channel 112 of the cartridge. A porous media 114, such as a filter (such as metal, foam, felt, etc.), is heat staked to the bottom wall 116 of the cartridge. As seen in FIG. 12A, the filter may be further nested on a sloped surface 118 to allow the filter to be easily heat staked. The filter may be bent upon being heat staked to the bottom wall. The filter contacts the bottom floor to allow ink to wick into the inlet channel with increased efficiency.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An ink cartridge comprising:
a first wall;
a plurality of side walls extending from said first wall to form an internal cavity between said side walls and said first wall, wherein said internal cavity is substantially filled with ink;
a cover which is attached to said plurality of said walls;
an ink supply port formed in one of said plurality of side walls;
an ink supply flow path formed in said first wall and extending to said ink supply port; and
a porous member interposed between said ink supply flow path and said ink supply port for minimizing formation of bubbles in ink in said ink supply flow path and said ink supply port.

2. The ink cartridge of claim 1, wherein said porous member comprises foam.

3. The ink cartridge of claim 1, wherein said porous member comprises felt.

4. The ink cartridge of claim 1, further comprising a septum positioned within said ink outlet port.

5. The ink cartridge of claim 4, wherein said porous member is interposed between said ink flow path and said septum.

6. The ink cartridge of claim 1, further comprising a plurality of grooves formed in said ink flow path adjacent said porous member.

7. The ink cartridge of claim 1, wherein said porous member comprises unidirectional fibers.

8. The ink cartridge of claim 6, wherein said grooves comprise radiused corners.

9. The ink cartridge of claim 6, wherein said grooves comprise sharp corners.

10. The ink cartridge of claim 1, wherein said porous member is press fit into said ink supply port.

11. The ink cartridge of claim 1, wherein said porous member has a hole formed therethrough for receiving an associate ink supply needle, said hole being dimensioned to be less than a diameter of said ink supply needle.

12. The ink cartridge of claim 1, wherein said porous member comprises a first member and a second member disposed adjacent each other.

13. The ink cartridge of claim 1, wherein said porous member first member and said porous member second member each has an opening formed therethrough.

14. The ink cartridge of claim 1 wherein said ink flow path comprises a channel formed in one of said side walls of said cartridge.

15. An ink cartridge comprising:
a first wall;
a plurality of side walls extending from said first wall to form an internal cavity between said side walls and said first wall, wherein said internal cavity is substantially filled with ink;
a cover which is attached to said plurality of said walls;
an ink supply port formed in one of said plurality of side walls;
an ink supply flow path formed in said first wall and extending to said ink supply port; wherein said ink supply flow path comprises an inlet adjacent one of said side walls; and
a porous member positioned between said inlet of said ink supply flow path and said one of said side walls for minimizing formation of bubbles in ink in said ink supply flow path.

16. The ink cartridge of claim 15, wherein said porous member comprises a wire mesh.

17. The ink cartridge of claim 15, wherein said porous member comprises foam.

18. The ink cartridge of claim 17, wherein said porous member is nested in an angled surface.

19. The ink cartridge of claim 18, wherein said porous member is heat staked to said one of said side walls.
